(19) United States
(12) Patent Application Publication
(10) Pub. No.: US 2024/0353619 A1
(43) Pub. Date: Oct. 24, 2024

(54) OPTICAL WAVEGUIDE ELEMENT

(71) Applicant: The University of Tokyo, Tokyo (JP)

(72) Inventors: Yuto SUZUKI, Tokyo (JP); Takuo TANEMURA, Tokyo (JP); Abdulaziz Elsayed Mohamed ELFIQI, Tokyo (JP); Taichiro FUKUI, Tokyo (JP); Maiko ITO, Tokyo (JP); Yoshiaki NAKANO, Tokyo (JP)

(21) Appl. No.: 18/685,411

(22) PCT Filed: Aug. 29, 2022
(86) PCT No.: PCT/JP2022/032333

§ 371 Date: Feb. 21, 2024

(30) Foreign Application Priority Data
Aug. 30, 2021 (JP) 2021-140541

(51) Int. Cl. G02B 6/126

(52) U.S. Cl. CPC G02B 6/126

(57) ABSTRACT

Provided is an optical waveguide element having high polarization conversion efficiency even in an optical waveguide having a large core thickness. A core C22 of an optical waveguide 22 constituting a polarization separation and rotation unit 12 is formed in a tapered shape in which the width W₁ continuously gradually increases from the input end toward the output end. A groove 25 having a V-shaped cross section is formed on the upper surface of the core C22. The groove 25 is formed on the upper surface of the core C22 to extend in the light propagation direction in the range from the input end to the output end of the core C22. In the optical waveguide 22, a waveguide mode in which an effective refractive index between an input end and an output end thereof is maximized is a TE0 mode, a second guided mode is a TM0 mode at the input end and a TE1 mode at the output end, and a transition is made from the TM0 mode to the TE1 mode from the input end toward the output end.

### TECHNICAL FIELD

The present invention relates to an optical waveguide element.

### BACKGROUND ART

In an optical circuit, for example, an optical circuit using a substrate-type optical waveguide element provided with an optical waveguide, there is generally polarization dependency, and it is important to control polarization. Polarization rotator-splitters that separate and rotate the polarization of light are known.

For example, the polarization rotator-splitters described in NPL 1 include an optical waveguide similar to a rib-type optical waveguide. The polarization rotator-splitters have a tapered shape in which the width of the rib constituting the core continuously gradually increases in the propagation direction of light, and have a shape in which the width of the slabs on both sides gradually decreases after gradually increasing. As a result, between a TE0 mode in which a main component of an electric field becomes in an in-plane direction of a substrate provided with the optical waveguide and a TM0 mode in which a main component of a magnetic field becomes in an in-plane direction of a substrate (the main component of the electric field is in the direction perpendicular to the surface of the substrate), the light propagates through the optical waveguide as it is in the TE0 mode, and in the TM0 mode, is rotated and converted into that in a TE1 mode. As described above, the polarization rotator-splitter separates the TE0 mode and the TM0 mode and converts the TM0 mode into the TE1 mode.

On the other hand, optical waveguides are roughly classified into thin wire optical waveguides having a core thickness (height) of 0.5 μm or less and optical waveguides (hereinafter, referred to as a thick film optical waveguide) having a core thickness of 1 μm or more. A thick film optical waveguide has advantages such as low loss and high reliability as compared with a thin wire optical waveguide, and high affinity with an optical fiber, and has been expected to be used in an in-vehicle optical network and data center communication in recent years.

### CITATION LIST

### Patent Literature

NPL 1: Wesley D. Sacher, Tymon Barwicz, Benjamin J. F. Taylor, and Joyce K. S. Poon “Polarization rotator-splitters in standard active silicon photonics platforms”, Optics Express Vol. 22, Issue 4, pp. 3777-3786 (2014)

### SUMMARY OF THE INVENTION

### Technical Problem

Incidentally, when it is attempted to realize the polarization separation rotation in the thick film optical waveguide using the structure of the polarization rotator-splitter described in NPL 1, there is a problem that the polarization conversion efficiency for converting the TM0 mode into the TE1 mode is low, and the optical waveguide element which is required for the polarization separation rotating element becomes long.

The present invention has been made in view of the above circumstances, and an object of the present invention is to provide an optical waveguide element having high polarization conversion efficiency even in an optical waveguide having a large core thickness.

### Solution to Problem

An optical waveguide element of the present invention is an optical waveguide element including an optical waveguide having a core extending in one direction, and a groove formed on one surface of the core and extending in a light propagation direction, in which one or both of a width of the core and an opening width of the groove on the one surface change continuously, and the optical waveguide allows a TE0 mode of light input from an input end to propagate as it is to an output end, and allows a TM0 mode and a TE1 mode of light input from an input end to mutually perform mode conversion between the TM0 mode and the TE1 mode and to propagate to an output end.

### Advantageous Effects of the Invention

According to the present invention, since asymmetry of the cross-sectional shape of the core is generated by the groove formed on one surface of the core, the action by the groove acts on the central portion of the core. Therefore, even in an optical waveguide having a large thickness, conversion from the TM0 mode to the TE1 mode can be effectively performed.

### BRIEF DESCRIPTION OF DRAWINGS

FIG. 1 A perspective view illustrating a configuration of an optical circuit in which a polarization separation and rotation unit is formed.

FIG. 2 A plan view illustrating details of an optical waveguide of an optical circuit.

FIG. 3 A cross-sectional view illustrating a cross-sectional shape of a core in a polarization separation and rotation unit.

FIG. 4 An explanatory diagram illustrating a change in electric field distributions in a core of the polarization separation and rotation unit.

FIG. 5 An explanatory diagram illustrating a combination of a width of a core and an opening width of a groove in the polarization separation and rotation unit.

FIG. 6 A cross-sectional view illustrating an example of a groove having an arc cross-sectional shape.

FIG. 7 A cross-sectional view illustrating an example of a groove having a trapezoidal cross-sectional shape.

FIG. 8 A cross-sectional view illustrating an example of a rib-type optical waveguide.

FIG. 9 A plan view illustrating an example in which a branching unit is configured by an asymmetric directional coupler.

FIG. 10 A simulation image illustrating a result of numerical simulation in which a TE0 mode light is input to an optical circuit in a case where a cross-sectional shape of a groove is a V shape, an opening width is constant, and a width of a core changes.

FIG. 11 A simulation image illustrating a result of numerical simulation in which a TM0 mode light is input to an optical circuit in a case where a cross-sectional shape of a groove is a V shape, an opening width is constant, and a width of a core is changed.

FIG. 12 A simulation image illustrating a result of simulating the magnitude of the electric field component in the x direction of the second mode with respect to a combination of the width of the core and an opening width of the groove.

FIG. 13 A simulation image illustrating a result of numerical simulation in which the TE0 mode light is input to an optical circuit in a case where a cross-sectional shape of a groove is a V shape, an opening width is changed, and a width of a core is constant.

FIG. 14 A simulation image illustrating a result of numerical simulation in which the TM0 mode light is input to an optical circuit in a case where a cross-sectional shape of a groove is a V shape, an opening width is changed, and a width of a core is constant.

FIG. 15 A simulation image illustrating a result of numerical simulation in which the TE0 mode light is input to an optical circuit in a case where a cross-sectional shape is a groove having an arc shape.

FIG. 16 A simulation image illustrating a result of numerical simulation in which the TM0 mode light is input to an optical circuit in a case where a cross-sectional shape is a groove having an arc shape.

FIG. 17 A simulation image illustrating a result of numerical simulation in which the TE0 mode light is input to an optical circuit in a case where a groove having a trapezoidal cross-sectional shape is used.

FIG. 18 A simulation image illustrating a result of numerical simulation in which the TM0 mode light is input to an optical circuit in a case where a groove having a trapezoidal cross-sectional shape is used.

FIG. 19 A graph illustrating a result of propagation simulation performed on a rib-type optical waveguide by an eigenmode expansion method.

### DESCRIPTION OF EMBODIMENTS

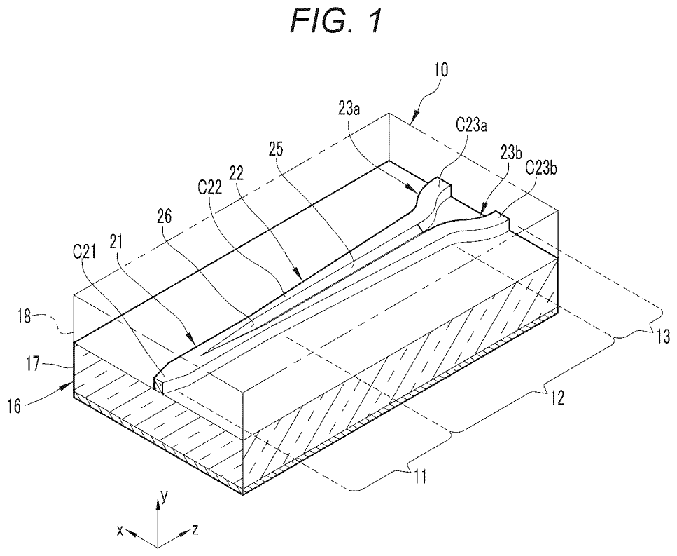

In FIG. 1, in an optical circuit 10 as a polarization separation rotator in this embodiment, a transition unit 11, a polarization separation and rotation unit 12 as an optical waveguide element as a main body of the optical circuit 10, and a branching unit 13 are formed on a substrate 16. In the optical circuit 10, input light from an input optical waveguide (not illustrated) is input to the polarization separation and rotation unit 12 via the transition unit 11, two orthogonal polarizations of the input light are separated by the polarization separation and rotation unit 12, the polarization plane of one polarization is rotated, the other polarization is propagated as it is, and they are output via the branching unit 13.

The optical circuit 10 includes a lower clad layer 17 provided on the surface of the substrate 16, a core formed on the flat surface of the lower clad layer 17, and an upper clad layer 18 formed on the lower clad layer 17 to embed the core. The lower clad layer 17 and the upper clad layer 18 have a refractive index lower than that of the core, and form a channel type optical waveguide together with the core formed on the substrate 16.

In the transition unit 11, a core C21 is provided, and an optical waveguide 21 is formed. In the polarization separation and rotation unit 12, a core C22 is provided, and an optical waveguide 22 is formed. The branching unit 13 is provided with cores C23a and C23b, and two optical waveguides 23a and 23b are formed correspondingly. As will be described in detail later, a groove 25 extending in the light propagation direction is formed in the core C22, and a groove 26 connected to the groove 25 is formed in the core C21. The cores C21, C22, C23a, and C23b have the same thickness. Note that the cores C21, C22, C23a, and C23b are collectively referred to as the core C unless otherwise distinguished.

In the optical circuit 10 in this example, the lower clad layer 17 and the upper clad layer 18 are formed of silica (SiO₂), and the core C is formed of silicon (Si). Types like the optical circuit 10 are similar to that manufactured using a known SOI substrate. Note that the materials of the core C, the lower clad layer 17, and the upper clad layer 18 are not limited to those described above as long as the refractive index of the core C is higher than the refractive indexes of the lower clad layer 17 and the upper clad layer 18. As the material of the core C, the lower clad layer 17, and the upper clad layer 18, in addition to silica and silicon, for example, dielectric materials such as silicon nitride (Si₃N₄), aluminum nitride (AlN), and lithium niobate (LiNbO₃), semiconductor materials such as gallium arsenide (GaAs), gallium nitride (GaN), aluminum gallium arsenide (AlGaAs), indium phosphide (InP), and indium gallium arsenide phosphide (InGaAsP), polymer materials, and the like can be used, and an appropriate material can be selected by a combination in which the refractive index of the core C is higher than that of the lower clad layer 17 and the upper clad layer 18. In addition, the upper clad layer 18 may be an air layer made of air.

In this example, the optical circuit 10 forms the core C having a thickness (height) and a width of 1 μm or more using a thick SOI substrate having a silicon layer thickness of 1 μm or more. However, the thickness and the width of the core C may be smaller than 1 μm. For example, each part of the optical circuit 10 may be configured as a thin wire optical waveguide with the thickness of the core C set to 0.5 μm or less.

In the following description, as illustrated in FIG. 1, an x direction, a y direction, and a z direction are directions orthogonal to each other, a propagation direction of light (direction in which the core C extends) is a z direction, a thickness direction of the substrate 16 (core C) is a y direction, and a width direction of the substrate 16 (core C) is an x direction. In addition, unless otherwise specified, the cross section will be described as a cross section orthogonal to the propagation direction (z direction) of light.

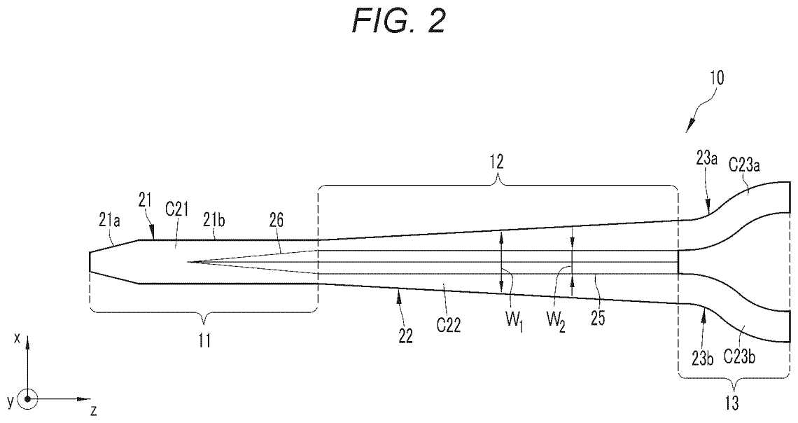

In FIG. 2, when the input light is input to the polarization separation and rotation unit 12, the transition unit 11 reduces the loss of the input light, and is provided between the input optical waveguide (not illustrated) and the polarization separation and rotation unit 12. The optical waveguide 21 of the transition unit 11 in this example includes a tapered region 21a which is disposed on the input optical waveguide side and in which the width of the core C21 gradually increases, and a linear region 21b which is disposed between the tapered region 21a and the polarization separation and rotation unit 12 and in which the width of the core C21 is constant. The tapered region 21a has a tapered shape in which the width of the end portion of the core C21 on the input optical waveguide side is the same as the width of the input optical waveguide, and the width continuously gradually increases toward the polarization separation and rotation unit 12. The width of the end portion of the core C21 on the linear region 21b side in the tapered region 21a and the width of the core C21 in the linear region 21b are the same as the width of the end portion of the core C22 on the transition unit 11 side of the polarization separation and rotation unit 12.

The groove 26 having a V-shaped cross section extending in the light propagation direction is formed on the upper surface of the core C21 in the linear region 21b. The groove 26 is formed at the center of the upper surface of the core C21 in the width direction. The depth of the groove 26 continuously gradually increases toward the polarization separation and rotation unit 12 while the inclination angle of the surface in the groove 26 remains constant. Therefore, the opening width of the groove 26 on the upper surface of the core C21 in the linear region 21b continuously gradually increases toward the polarization separation and rotation unit 12. The cross-sectional shape of the end portion of the core C21 on the polarization separation and rotation unit 12 side coincides with the cross-sectional shape of the end portion of the core C22 of the polarization separation and rotation unit 12 on the transition unit 11 side. The transition unit 11 configured as described above causes adiabatic transition of the input light for the optical waveguide 22.

As described above, the polarization separation and rotation unit 12 separates two orthogonal polarizations, rotates and propagates one polarization plane thereof, and propagates the other polarization plane as it is. The polarization separation and rotation unit 12 propagates the TE0 mode out of the TE0 mode and the TM0 mode, which are two orthogonal polarizations of the input light input from the transition unit 11, as it is, and converts the TM0 mode, that is, rotates the polarization plane to the TE1 mode.

The TE0 mode is a zero-order transverse electric field mode, and is a mode of light in which the electric field direction of light is mainly in the horizontal direction (x direction) and faces the same direction (+x direction or −x direction) over the entire cross section of the core C. The TM0 mode is a mode that becomes a zero-order transverse magnetic field of light, and is a mode of light in which the electric field direction of the light is mainly in the vertical direction (y direction) and is directed in the same direction (+y direction or −y direction) over the entire cross section of the core C. The TE1 mode is a primary transverse electric field mode, and is a mode of light in which the electric field direction of light is mainly in the horizontal direction (x direction), and the directions of the electric fields are opposite to each other in two ranges sandwiching the center line of the cross section of the core C in the width direction.

In this example, one end (end portion on the transition unit 11 side) of the optical waveguide 22 of the polarization separation and rotation unit 12 is an input end to which input light is input, and the other end (end portion on the branching unit 13 side) is an output end to which the TE0 mode light and the TE1 mode light are output. The optical waveguide 22 is formed in a tapered shape in which a width W₁ of the core C22 is continuously gradually increased from the input end toward the output end, and the groove 25 having a V-shaped cross section is formed on the upper surface of the core C22 for the separation and rotation of the polarized waves. The groove 25 is formed at the center of the upper surface of the core C22 in the width direction to extend in the light propagation direction in the range from the input end to the output end of the core C22.

Note that the upper surfaces of the cores C21 and C22 in this example are surfaces of the cores C21 and C22 on the opposite side to the lower clad layer 17, and these upper surfaces are one surface in which the grooves 25 and 26 are formed. The grooves 25 and 26 may be formed on the surface of the core C22 parallel to the propagation direction of light and the width direction of the core C22. A surface of the groove 26 formed in the core C21 is selected to be continuous with the groove 25.

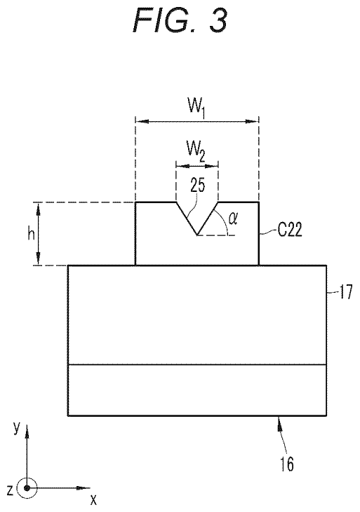

As illustrated in FIG. 3, the groove 25 has a cross-sectional shape of a V shape symmetrical with respect to the center line of the width, and is formed such that the magnitudes of the inclination angles α of the inclined surfaces in the groove 25 are the same. An opening width (length in the x direction) W₂ of the groove 25 on the upper surface of the core C22 is smaller than the width W₁ of the core C22. Further, the groove 25 has a depth smaller than a thickness h of the core C22, and does not divide the core C22 into two. In this example, the opening width W₂, the depth, and the inclination angle α of the groove 25 are constant, and do not change in the light propagation direction, but may change. In FIG. 3, hatching is omitted.

By the continuous change in the width W₁ of the core C22 and the asymmetry in the thickness direction (y direction) of the cross-sectional shape of the core C22 by the groove 25 as described above, the eigenmode of the optical waveguide 22 is changed in the propagation direction of light, and conversion from the TM0 mode to the TE1 mode is realized.

The groove 25 causes asymmetry in the thickness direction in the core C22, and causes a large difference in effective refractive index between a waveguide mode (hereinafter, referred to as a second mode) having the second largest effective refractive index (equivalent refractive index) and a waveguide mode (hereinafter, referred to as a third mode) having the third largest effective refractive index in the optical waveguide 22 over the entire length of the optical waveguide 22. As a result, while the TE0 mode of the input light input to the optical waveguide 22 is maintained, the TM0 mode is effectively converted into the TE1 mode while following the eigenmode of the optical waveguide 22. Note that the asymmetry of the core C22 in the thickness direction (y direction) means that the upper portion and the lower portion of the symmetry axis parallel to the x direction passing through the center in the thickness direction are not symmetric in the cross section of the core C22.

With the groove 25, even in the optical waveguide 22 using the core C22 having a thickness of 1 μm or more, the TM0 mode is effectively and stably converted into the TE1 mode because the action by the groove 25 is exerted on the central portion of the thick core C22. As a result, the length of the optical waveguide 22 can be shortened, which is advantageous for miniaturization of the optical circuit 10. In order to shorten the optical waveguide 22, it is also preferable to change the change rate of the width W₁ of the core C22 depending on the effective refractive index difference between the second mode and the third mode.

The grooves 25 and 26 can be formed, for example, by performing anisotropic wet etching on the upper surfaces of the cores C21 and C22 using a mask opened with a width corresponding to the opening widths of the grooves 25 and 26. The upper clad layer 18 is embedded in the grooves 25 and 26.

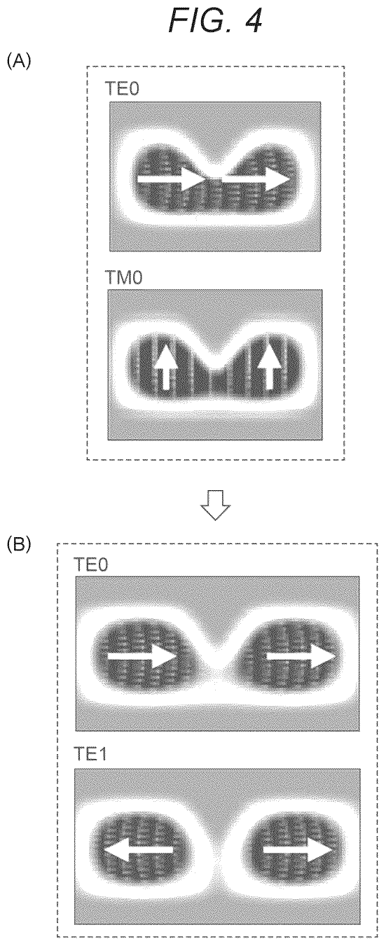

The output terminal of the optical waveguide 22 outputs the TE0 mode light and the TE1 mode light converted from the TM0 mode. (A) of FIG. 4 illustrates an example in which the electric field distribution in the TE0 mode and the electric field distribution in the TM0 mode at the input end of the optical waveguide 22 are obtained by simulation, and (B) of FIG. 4 illustrates an example in which the electric field distribution in the TE0 mode and the electric field distribution in the TE1 mode at the output end are obtained by simulation.

As illustrated in FIG. 4, by forming the groove 25 in the core C22, the light intensity of the TE0 mode light at the center of the core C22 in the width direction gradually decreases, and the light intensity increases at the center portions of two ranges on both sides across the center line of the core C22 in the width direction. As a result, the TE0 mode is output as light having a light intensity distribution having peaks on both sides across the center line. That is, the TE0 mode light is divided into the TE0 mode light of substantially the same phase in the optical waveguide 22 by the groove 25 and output from the optical waveguide 22.

On the other hand, the TM0 mode light is converted into the TE1 mode light, and is output from the optical waveguide 22 as light having a light intensity distribution in which the directions of the electric fields are opposite to each other in two ranges on both sides across the center line in the width direction of the core C22, but the light has peaks at the central portions of the two ranges. That is, the TE1 mode light is divided into the TE0 mode lights having phases substantially opposite to each other and output from the optical waveguide 22.

As illustrated in FIG. 2, the branching unit 13 in this example is configured as a mode-independent branching unit, specifically, a Y-shaped coupler. The branching unit 13 includes the two optical waveguides 23a and 23b as described above. One end of a core C23a constituting the optical waveguide 23a is coupled to one of two ranges on both sides across the center line of the core C22 in the width direction at the output end of the optical waveguide 22, and one end of the core C23b constituting the optical waveguide 23b is coupled to the other. As a result, the TE1 mode light converted from the TM0 mode is divided into the TE0 mode lights of opposite phases and input to the optical waveguides 23a and 23b, and the TE0 mode light is divided into the TE0 mode lights of the same phase and input to the optical waveguides 23a and 23b. As a result, the linear sum of a TE component and a TM component of the input light is output from the optical waveguides 23a and 23b.

When a complex electric field component (complex electric field component in the x direction) of the input light of the TE0 mode is denoted by Ex and a complex electric field component (complex electric field component in the y direction) of the input light of the TM0 mode is denoted by Ey·e^{iθ}, light having “Ex+Ey·e^{iθ}” as an electric field component is output from the optical waveguide 23a, and light having “Ex−Ey·e^{iθ}” is output from the optical waveguide 23b. Note that the value e is a difference in phase change received when the TE0 mode and the TM0 mode of the input light propagate through the optical circuit 10. In a case where the phase difference is an integral multiple of 2n (θ=2π×integer), the optical circuit 10 serves as a polarization separation rotator that separates a linearly polarized component of ±45° of the input light. In addition, in a case where the phase difference is not an integral multiple of 2π, the optical circuit 10 serves as a polarization separation rotator that separates elliptically polarized components whose rotation directions of the input light are opposite to each other. In any case, since the input light is separated with the orthogonal polarization component as a basis, the configuration of the branching unit 13 can be simplified.

In the optical waveguide 22 in the above example, the width W₁ of the core C22 continuously gradually increases toward the output end thereof, and the opening width W₂ of the groove 25 is constant, but it is not limited thereto. For the optical waveguide 22, one or both of the width W₁ of the core C22 and the opening width W₂ of the groove 25 may be determined to continuously change, so that the waveguide mode in which the effective refractive index between the input end and the output end is maximized (hereinafter, referred to as a first mode) is the TE0 mode, the second mode is the TM0 mode at the input end and the TE1 mode at the output end, and a transition is made from the TM0 mode to the TE1 mode toward the output end from the input end. At this time, in the optical waveguide 22, between a section in which the second mode becomes the TM0 mode and a section in which the second mode becomes the TE1 mode, there is an intermediate region in which the second mode is a mode represented by the linear sum of the TM0 mode and the TE1 mode.

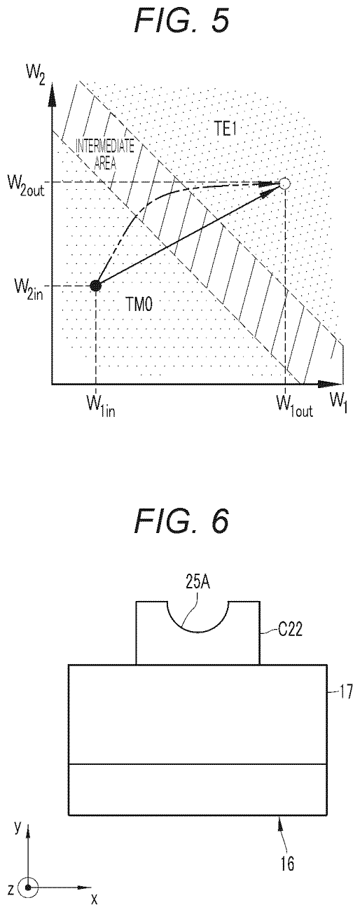

In other words, in the second mode, as illustrated in FIG. 5, there are a combination (W₁ᵢₙ, W₂ᵢₙ) of the width W₁ and the opening width W₂ at the input end in the region where the second mode becomes the TM0 mode and a combination (W₁ₒᵤₜ, W₂ₒᵤₜ) of the width W₁ and the opening width W₂ at the output end in the region where the second mode becomes the TE1 mode. The combination of the width W₁ and the opening width W₂ in each portion of the entire section of the core C22 may be determined so as to continuously change from the combination (W₁ᵢₙ, W₂ in) of the input ends to the combination (W₁ₒᵤₜ, W₂ₒᵤₜ) of the output ends through the combination that becomes the intermediate region. At this time, the combination of the width W₁ and the opening width W₂ may be changed linearly as indicated by a solid line in FIG. 5, or may be changed in a curved line as indicated by a two-dot chain line. Further, only the other one of the width W₁ and the opening width W₂ may be continuously changed while one of the width W₁ and the opening width W₂ is kept constant. That is, only the opening width W₂ may be continuously changed while keeping the width W₁ constant, or only the width W₁ may be continuously changed while keeping the opening width W₂ constant.

As can be seen from the above description, in the optical waveguide 22, the combination of the width W₁ and the opening width W₂ only needs to transition from a region where the second mode is the TM0 mode to the region where the second mode becomes the TE1 mode through the intermediate region, from the input end toward the output end. Further, as a matter of course, the combination of the width W₁ and the opening width W₂ is determined such that the first mode in the entire section of the optical waveguide 22 becomes the TE0 mode.

As described above, the groove 25 generates asymmetry in the thickness direction in the core C22 to increase the difference in the effective refractive index between the second mode and the third mode over the entire length of the optical waveguide 22, particularly in the intermediate region, thereby ensuring conversion from the TM0 mode to the TE1 mode. From such a viewpoint, the groove 25 may have any shape as long as asymmetry in the thickness direction occurs in the core C22. For this reason, the groove 25 may not make the cross-sectional shape of the core C22 symmetrical with respect to the center line of the width. Therefore, the formation position of the groove 25 on the upper surface of the core C22 does not need to be at the center, and the cross-sectional shape of the groove 25 does not need to be symmetrical with respect to the center line of the width. A configuration in which the cross-sectional shape of the core C22 is symmetrical with respect to the center line of the width, that is, a configuration in which the formation position of the groove 25 on the upper surface of the core C22 is set as the center and the cross-sectional shape is also symmetrical with respect to the center line of the width is a preferable aspect from the viewpoint of ease of design and manufacture. In addition, the configuration in which the cross-sectional shape of the core C22 is symmetrical with respect to the center line of the width is also a preferable aspect in that a Y-shaped coupler having a simple configuration using the above-described two optical waveguides 23a and 23b can be used as the branching unit 13. In a case where the cross-sectional shape of the core C22 is symmetrical with respect to the center line of the width, the cross-sectional shape of the core C22 does not need to be strictly symmetrical with respect to the center line of the width. Therefore, in this case, the formation position of the groove 25 on the upper surface of the core C22 need not be strictly central, and the cross-sectional shape of the groove 25 also need not be strictly symmetrical with respect to the center line of the width.

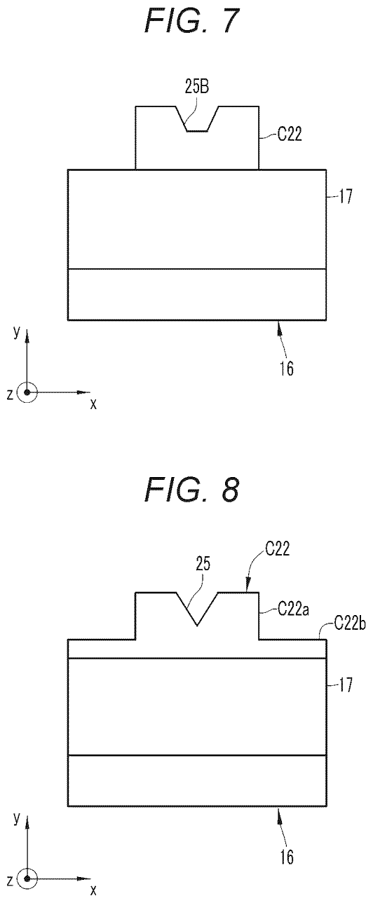

The groove formed in the core of the polarization separation and rotation unit in the above example is a V-shaped groove having a V-shaped cross section, but the groove may have any shape as long as asymmetry in the thickness direction occurs in the core in which the groove is formed. For example, in the example illustrated in FIG. 6, a groove 25A is an arcuate groove having an arcuate cross-sectional shape. In addition, in the example illustrated in FIG. 7, a groove 25B is a trapezoidal groove having a trapezoidal cross-sectional shape. In the groove 25B, the width of the groove bottom portion corresponding to one of two parallel sides of the trapezoid is shorter than the opening width of the opening portion corresponding to the other one side. In addition, the cross-sectional shape of the groove may be a U-shape, a rectangular shape, or the like. Also in this case, the symmetry with respect to the center line of the width of the cross-sectional shape of the core C22, the formation positions of the grooves 25A and 25B, and the symmetry of the cross-sectional shape are not necessarily strict as with the groove 25. In FIGS. 6 and 7, hatching is omitted.

Note that the groove formed in the core of the polarization separation and rotation unit is preferably a groove having a cross-sectional shape having a straight line or a curved line inclined with respect to the y direction, such as a V-shaped groove or an arc groove. With such a cross-sectional shape, the effect due to the asymmetry in the thickness direction of the core can be increased, which is advantageous in reducing the overall length of the optical waveguide in the polarization separation and rotation unit.

In each of the above examples, the example of the channel type optical waveguide has been described, but as illustrated in the example of FIG. 8, a rib type (ridge type) optical waveguide may be used. Also in this case, the depth of the groove 25 may be smaller than the thickness of the core C22, that is, the sum of the thickness of the rib C22a and the thickness of a slab C22b. In FIG. 8, hatching is omitted.

In the above description, a Y-shaped coupler using two optical waveguides is used as the branching unit, but the configuration of the branching unit is not limited thereto. For example, when a directional coupler that selectively extracts the TE0 mode or the TE1 mode is used as the branching unit, the TE0 component and the TM0 component of the input light can be directly separated and extracted.

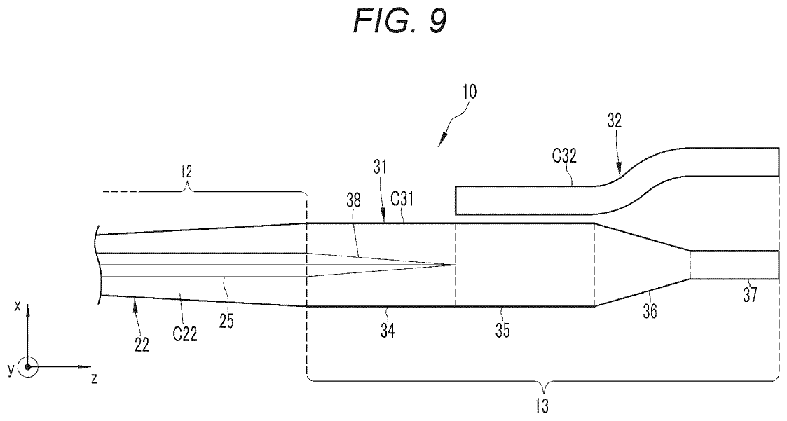

FIG. 9 illustrates an example in which the branching unit 13 is configured as an asymmetric directional coupler. The branching unit 13 in this example includes an optical waveguide 31 including a core C31 and an optical waveguide 32 including a core C32. In the optical waveguide 31, a transition region 34, a coupling region 35, a tapered region 36, and an optical waveguide region 37 are connected in order from the polarization separation and rotation unit 12 side.

The width of the core C31 of the transition region 34 and the coupling region 35 of the optical waveguide 31 is the same as the width of the output end of the core C22 of the optical waveguide 22. In the transition region 34, a groove 38 having one end connected to the groove 25 and the other end extending toward the coupling region 35 is formed on the upper surface of the core C31. The groove 38 has the same cross-sectional shape as the groove 25, in this example, a V-shaped cross section, and the opening width and the depth gradually decrease continuously toward the coupling region 35 and finally disappear while the inclination angle of the surface in the groove is maintained constant. By the transition region 34 configured as described above, the light from the optical waveguide 22 adiabatically transitions to the coupling region 35. The coupling region 35 is a region coupled to the optical waveguide 32 and is a multimode optical waveguide. The tapered region 36 has a tapered shape in which the width of the core C31 is continuously tapered, and constitutes an optical waveguide that adiabatically shifts the multi-mode to the single-mode. The optical waveguide region 37 is a single-mode optical waveguide.

The optical waveguide 32 is configured as a single-mode optical waveguide, and one end portion of the core C32 is provided close to the coupling region 35. An effective coupling length between the coupling region 35 and one end portion of the optical waveguide 32 is determined such that the TE1 mode propagating through the coupling region 35 of the optical waveguide 31 is coupled to the TE0 mode of the optical waveguide 32, and the TE0 mode propagating through the coupling region 35 is not coupled to the optical waveguide 32. Note that the configuration of the optical waveguide 31 is not limited to the above, and for example, the width of the coupling region 35 may be made larger than that of the transition region 34, and a tapered region in which the width continuously gradually increases toward the coupling region 35 may be provided between the transition region 34 and the coupling region 35.

According to the above configuration, the TM0 mode light of the input light input to the optical waveguide 22 of the polarization separation and rotation unit 12 is converted into the TE1 mode light during propagation of the optical waveguide 22. Then, the TE1 mode light is coupled to the TE0 mode of the optical waveguide 32 in the coupling region 35 of the optical waveguide 31, and is output to the optical waveguide 32 as the TE0 mode light. Meanwhile, the TE0 mode light of the input light input to the polarization separation and rotation unit 12 propagates through the optical waveguide 22 of the polarization separation and rotation unit 12 and the optical waveguide 31 of the branching unit 13, and is output to the optical waveguide region 37 of the optical waveguide 31 without being coupled to the optical waveguide 32. In this manner, the TM0 mode component of the input light can be separated and extracted from the optical waveguide 32, and the TE0 mode component can be separated and extracted from the optical waveguide region 37.

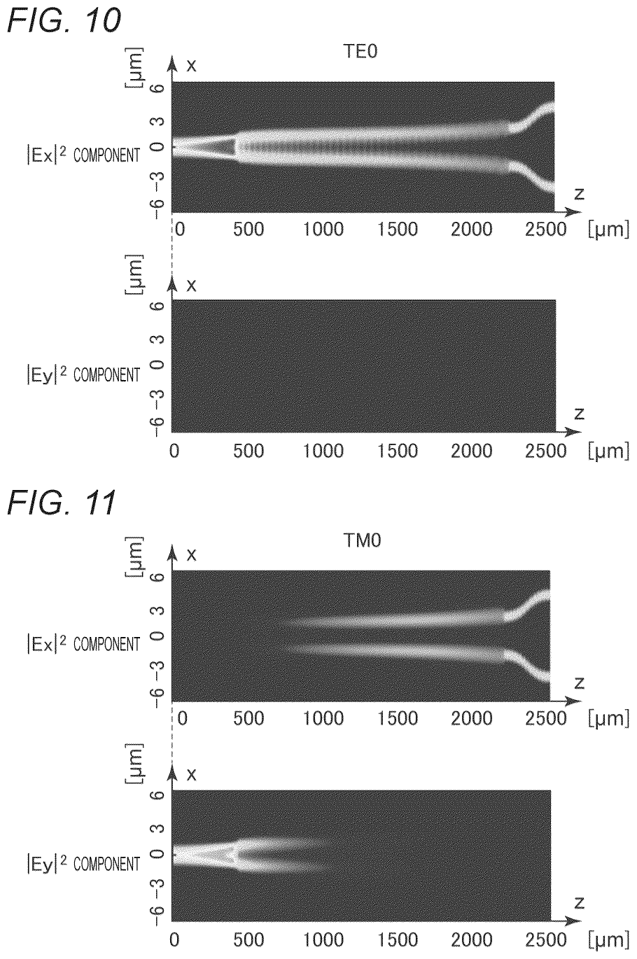

FIGS. 10 and 11 illustrate results of numerical simulation of the optical circuit 10 in a case where the TE0 mode light and the TM0 light mode having a wavelength of 1550 nm are input. FIG. 10 illustrates a square value (|Ex|²) of the x-direction component and a square value (|Ey|²) of the y-direction component of the electric field in each optical waveguide when the light (Ex component) of TE0 is input to the optical circuit 10 as the input light. In addition, FIG. 11 illustrates a square value (|Ex|²) of the x-direction component and a square value (|Ey|²) of the y-direction component of the electric field in each optical waveguide when the light (Ey component) of TM0 is input to the optical circuit 10 as the input light.

In the numerical simulation for the optical circuit 10, the opening width W₂ of the groove 25 is set to 1.3 μm (constant in the entire section of the core C22), the width W₁ at the input end of the core C22 is set to 3 μm, the opening width W₂ at the output end is set to 7 μm, and the width W₁ is continuously changed (increased) from the input end to the output end. The thickness of each core of the optical circuit 10 including the core C22 was 1.8 μm, and the inclination angle α of the inclined surface of the groove 25 having a V-shaped cross section was 54.7°. In addition, the length of the optical waveguide 22 was set to about 1800 μm. In this numerical simulation, the light wavelength of the TE0 mode light and the TM0 mode light are 1550 nm, and the upper clad layer 18 is air. Note that the light wavelength of the TE0 mode light and the TM0 mode light are set to 1550 nm, and the upper clad layer 18 is set to air, which is the same for the following other numerical simulations.

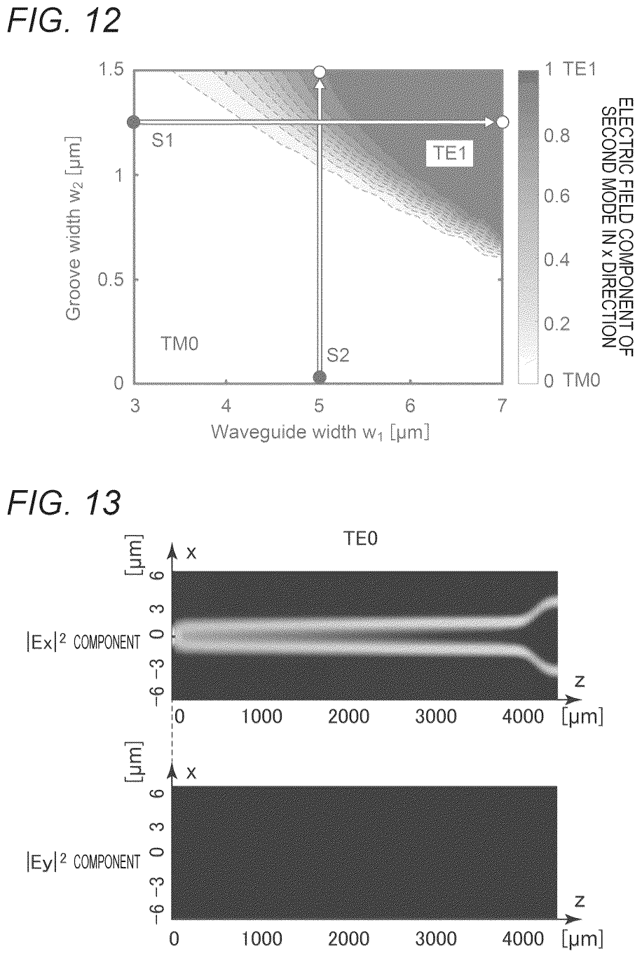

FIG. 12 is a simulation of the magnitude of the electric field component in the x direction of the second mode with respect to the combination of the width W₁ of the core C22 and the opening width W₂ of the groove 25 with the thickness of the core C22 set to 1.8 μm, and illustrates a region in which the second mode becomes the TM0 mode and a region in which the second mode becomes the TE1 mode. A region in which the electric field component in the x direction of the second mode is “0” is a region in which the second mode becomes the TM0 mode, and a region in which the electric field component in the x direction of the second mode is “1” is a region in which the second mode becomes the TE1 mode. The width W₁ is in a range of 3 μm to 7 μm, and the opening width W₂ is in a range of 0 μm to 1.5 μm.

The numerical simulation for the optical circuit 10 determines a combination of the width W₁ and the opening width W₂, and corresponds to the combination of the width W₁ and the opening width W₂ so that the second mode of the optical waveguide 22 changes from the region where the second mode becomes TM0 to the region where the second mode becomes TE1, as indicated by an arrow S1 in FIG. 12. The first mode was the TE0 mode.

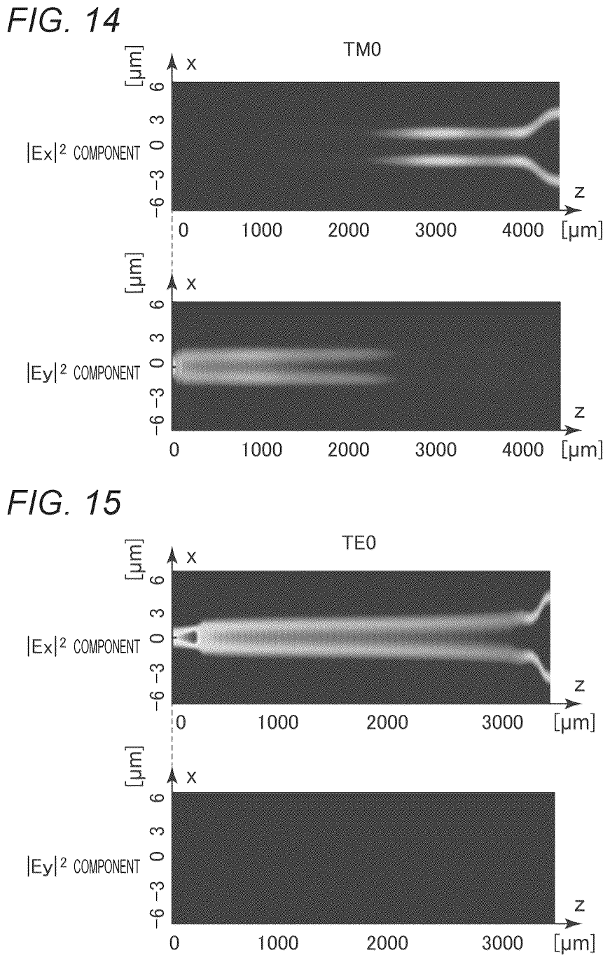

FIGS. 13 and 14 illustrate results of numerical simulation on the optical circuit 10 with the width W₁ of the core C22 being constant and the opening width W₂ of the groove 25 being continuously changed. Similarly to the above, FIG. 13 illustrates the square value (|Ex|²) of the x-direction component of the electric field in each optical waveguide in a case where the light (Ex component) of TE0 is input to the optical circuit 10 as the input light and FIG. 14 illustrates the square value (|Ey|²) of the y-direction component of the electric field in each optical waveguide in a case where the light (Ey component) of TM0 is input to the optical circuit 10 as the input light.

In the numerical simulation for the optical circuit 10, the width W₁ at the input end of the core C22 is set to 5 μm, the opening width W₂ of the groove 25 at the input end of the core C22 is set to 0 μm, and the opening width W₂ at the output end is set to 1.5 μm, and the opening width W₂ is continuously changed (increased) from the input end to the output end. The numerical simulation for the optical circuit 10 determines a combination of the width W₁ and the opening width W₂, and corresponds to the combination of the width W₁ and the opening width W₂ so that the second mode of the optical waveguide 22 changes from the region where the second mode becomes TM0 to the region where the second mode becomes TE1 as indicated by an arrow S2 in FIG. 12. The first mode was the TE0 mode. The thickness of each core of the optical circuit 10 and the inclination angle α of the inclined surface of the groove 25 are the same as those in the above numerical simulation, and the length of the optical waveguide 22 is about 4000 μm.

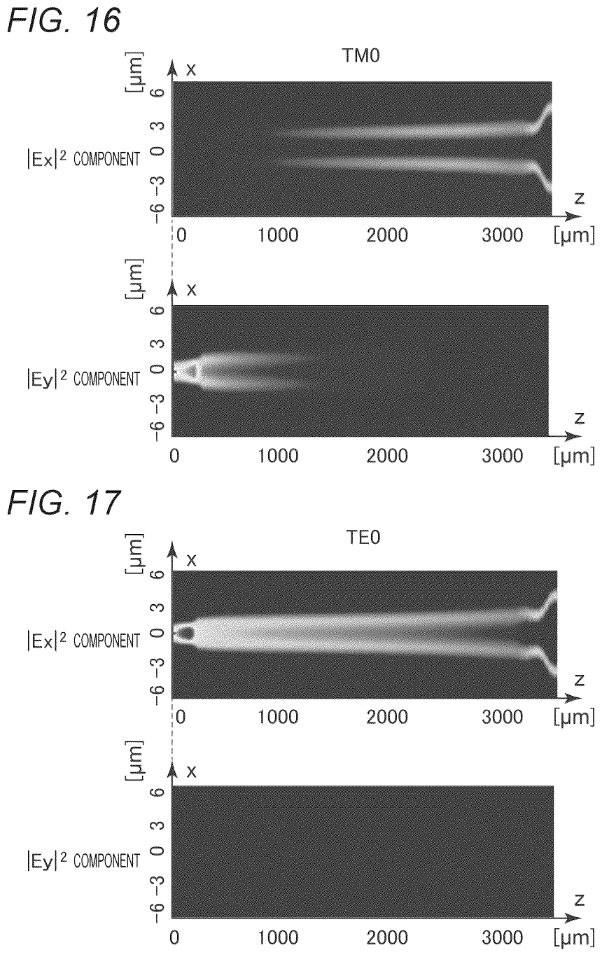

FIGS. 15 and 16 illustrate numerical simulation results for the optical circuit 10 in a case where the groove 25A having an arc-shaped cross section is formed in the core C22. Similarly to the above, FIG. 15 illustrates the square value (|Ex|²) of the x-direction component of the electric field in each optical waveguide in a case where the light (Ex component) of TE0 is input to the optical circuit 10 as the input light and FIG. 16 illustrates the square value (|Ey|²) of the y-direction component of the electric field in each optical waveguide in a case where the light (Ey component) of TM0 is input to the optical circuit 10 as the input light.

The groove 25A has a cross-sectional shape of a semicircular arc having a radius of 0.6 μm, and has a depth equal to the radius. That is, the opening width of the groove 25A was 1.2 μm (constant over the entire section of the core C22). The width W₁ at the input end of the core C22 is 3 μm, the opening width W₂ at the output end is 7 μm, and the width W₁ is continuously changed (increased) from the input end to the output end. The thickness of each core of the optical circuit 10 is the same as that in the above numerical simulation, and the length of the optical waveguide 22 is about 3000 μm.

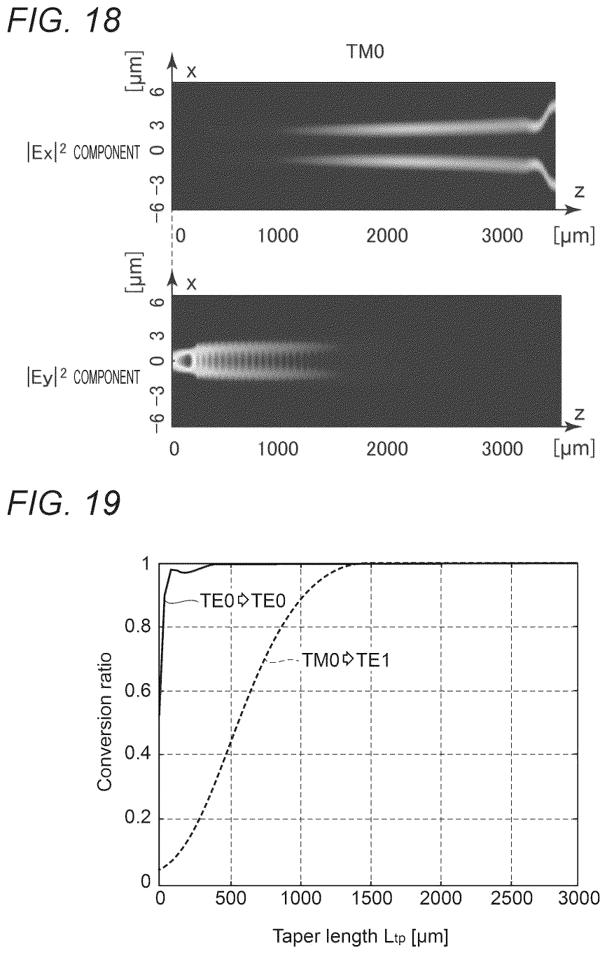

FIGS. 17 and 18 illustrate numerical simulation results for the optical circuit 10 in a case where the groove 25B having a trapezoidal cross section is formed in the core C22. Similarly to the above, FIG. 17 illustrates the square value (| Ex|²) of the x-direction component of the electric field in each optical waveguide in a case where the light (Ex component) of TE0 is input to the optical circuit 10 as the input light and FIG. 18 illustrates the square value (|Ey|²) of the y-direction component of the electric field in each optical waveguide in a case where the light (Ey component) of TM0 is input to the optical circuit 10 as the input light.

The groove 25B had a groove depth of 0.5 μm, an opening width W₂ of 2 μm, and a groove bottom width of 1.29 μm, which were constant over the entire section of the core C22. In addition, the width W₁ at the input end of the core C22 is 3 μm, the opening width W₂ at the output end is 7 μm, and the width W₁ is continuously changed (increased) from the input end to the output end. The thickness of each core of the optical circuit 10 is the same as that in the above numerical simulation. In addition, the length of the optical waveguide 22 was set to about 3000 μm.

As illustrated in each result of the numerical simulation for the optical circuit 10, it can be seen that the TE0 mode light input to the optical waveguide 22 propagates without being converted, is divided into two at the branching unit 13, and proceeds to the optical waveguides 23a and 23b. On the other hand, it can be seen that the TM0 mode light input to the optical waveguide 22 is converted into the TE1 mode during the propagation of the optical waveguide 22, is divided into the TE0 mode lights of opposite phases, and travels to the optical waveguides 23a and 23b.

FIG. 19 illustrates a result of propagation simulation performed on the rib-shaped optical waveguide 22 by the eigenmode expansion (EME) method. In this propagation simulation, the thickness of the core C22 was 1.8 μm, the thickness of the slab C22b was 0.9 μm, and the thickness of the rib C22a was 0.9 μm. In addition, the opening width W₂ of the groove 25 is 1.3 μm (constant over the entire section of the core C22), the width W₁ of the core C22 is 3 μm at the input end and 6 μm at the output end, and the width W₁ is continuously changed (increased) from the input end to the output end. The thickness of each core of the optical circuit 10 including the core C22 was 1.8 μm. The inclination angle a of the inclined surface of the groove 25 having a V-shaped cross section was 54.7°. Under such conditions, it was found that the conversion efficiency from TM0 to TE1 of 99% or more can be obtained by the optical waveguide 22 having a length (Ltp) of 1500 μm.

In the optical circuit 10 in each of the above examples, light is input from the transition unit 11 to the polarization separation and rotation unit 12, which is an optical waveguide element, and light is output from the branching unit 13. However, in the opposite direction, that is, it is also possible to input two lights into the optical waveguide element through the branching unit 13 and take out the light from the transition unit 11. In this case, the optical waveguide element used as the polarization separation and rotation unit 12 in the above example becomes a polarization rotation multiplexing unit that multiplexes and outputs two input lights in orthogonal polarization states, and the optical circuit 10 can be used as a polarization rotation multiplexer. For example, in a case where the branching unit 13 is configured as illustrated in FIG. 9, the TE0 mode light to be the TM0 mode as the output light is input to the optical waveguide 32, and the TE0 mode light to be the TE0 mode light as the output light is input to the optical waveguide region 37 as it is. Note that, in a case where the optical waveguide element is the polarization rotation multiplexing unit as described above, the other end (end portion on the branching unit 13 side) of the optical waveguide 22 is an input end, and one end (end portion on the transition unit 11 side) is an output end.

### REFERENCE SIGNS LIST

10: OPTICAL CIRCUIT
12: POLARIZATION SEPARATION AND ROTATION UNIT
21, 22, 23a, 23b, 31, 32: OPTICAL WAVEGUIDE
25, 25A, 25B, 26: GROOVE
37: OPTICAL WAVEGUIDE REGION
38: GROOVE
C: CORE

1. An optical waveguide element comprising:
an optical waveguide having a core extending in one direction; and
a groove formed on one surface of the core and extending in a light propagation direction, wherein
one or both of a width of the core and an opening width of the groove on the one surface change continuously, and the optical waveguide allows a TE0 mode of light input from an input end to propagate as it is to an output end, and allows a TM0 mode and a TE1 mode of light input from an input end to mutually perform mode conversion between the TM0 mode and the TE1 mode and to propagate to an output end.

2. The optical waveguide element according to claim 1, wherein,
in the optical waveguide,
a waveguide mode in which an effective refractive index is maximized is a TE0 mode, and
a waveguide mode having the second largest effective refractive index is a TM0 mode at one end and a TE1 mode at the other end, a transition is made from a TM0 mode to a TE1 mode from the one end toward the other end, and one of the one end and the other end is set as the input end and the other is set as the output end.

3. The optical waveguide element according to claim 1, wherein,
in the optical waveguide,
a transition is made from a TM0 mode to a TE1 mode through an intermediate region in which a waveguide mode having the second largest effective refractive index is a mode represented by a linear sum of a TM0 mode and a TE1 mode.

4. The optical waveguide element according to claim 1, wherein
the groove has a constant opening width, and
in the optical waveguide, a width of the core gradually increases from one end to the other end.

5. The optical waveguide element according to claim 1, wherein the groove has a V-shaped cross section orthogonal to the light propagation direction.
